(19) United States
(12) Patent Application Publication
(10) Pub. No.: US 2013/0046050 A1
(43) Pub. Date: Feb. 21, 2013

(54) HYBRID PARTICLES MADE OF POLYMERS AND NANOPARTICLES

(71) Applicants: Werner Siol, Darmstadt (DE); Klaus Langerbeins, Geesthacht (DE); Uwe Dietrich Kühner, Hamburg (DE)

(72) Inventors: Werner Siol, Darmstadt (DE); Klaus Langerbeins, Geesthacht (DE); Uwe Dietrich Kühner, Hamburg (DE)

(73) Assignee: Evonik Nanoresins GmbH., Geesthacht (DE)

(21) Appl. No.: 13/502,345

(22) PCT Filed: Oct. 18, 2010
(86) PCT No.: PCT/EP2010/065633

§ 371 Date: Jul. 9, 2012

(30) Foreign Application Priority Data
Oct. 16, 2009 (EP) 09013117.8

(51) Int. Cl. C08L 33/12; C08K 3/36; B82Y 30/00

(52) U.S. Cl. 524/458; 524/522; 525/209; 977/773

(57) ABSTRACT

Subject of the invention is a hybrid particle comprising at least two vinyl polymers (vinyl polymers A and B), wherein vinyl polymer A comprises colloidal SiO₂ particles with an average particle size from 1 to 150 nm and vinyl polymer B is capable of crosslinking hybrid particles to one another.

The invention relates to hybrid particles based on nanoscale SiO₂ particles and on at least two different vinyl polymers, to a dispersion which comprises the hybrid particles, and also to a polymeric material obtainable therefrom.

Polyacrylates and polymethacrylates have a long history in the prior art. They are used by way of example for producing plexiglass or so called acrylate rubbers.

Pure chemically crosslinked polyacrylates only have comparatively low strength. The mechanical properties of polymers can be improved by using fillers. Because acrylate groups are comparatively easily hydrolyzed, there are only a few fillers that can be used with polyacrylates, an example being carbon black. However, this impairs the transparency that is frequently desired with polyacrylates.

EP 1 216 262 describes a process for producing an aqueous dispersion of particles, wherein the particles are composed of polymer and of fine inorganic solid.

EP 0 505 230 A1 describes composit particles which consist of a polymer matrix which in each case wraps an SiO₂ particle. Angewandte Makromolekulare Chemie 242 (1996) 105-122 describes the production of latex particles by emulsion polymerization of ethyl acrylate in the presence of functionalized and non-functionalized SiO₂ particles.

The invention is based on the problem of providing hybrid particles which are versatile and which provide good mechanical properties to the polymeric materials that can be produced therefrom.

The subject of the present invention is therefore a hybrid particle comprising at least two vinyl polymers (vinyl polymers A and B), wherein vinyl polymer A comprises colloidal SiO₂ particles with an average particle size from 1 to 150 nm, and vinyl polymer B is capable of crosslinking the hybrid particles of the invention to one another.

The vinyl polymers A and B are different from one another. They can differ from one another by way of example in respect of their chemical constitution, their chemical nonuniformity, their tacticity, their glass transition temperature, their molecular weight, and/or their degree of crosslinking. The vinyl polymers A and B preferably differ in their monomeric composition. Thereby, the vinyl polymers can differ from one another in the monomers present or—provided that the same monomers are present in each case—in the proportions of the respective monomers.

The expression vinyl polymer means polymers obtainable via polymerization of vinyl monomers, and these polymers are preferably obtained via free-radical polymerization. The vinyl polymers can be homopolymers or copolymers, and are preferably copolymers. Homopolymers and copolymers based on esters of acrylic acid and methacrylic acid are of very particular interest.

A vinyl monomer is understood as a monomer which comprises an ethylenically unsaturated C—C bond, which is preferably terminal. The vinyl monomers are preferably capable of being free-radically polymerized.

Examples of vinyl monomers that can be used are dienes, such as isoprene or butadiene, vinyl halides, such as vinyl chloride, vinyl esters, such as vinyl acetate and vinyl esters of α-branched monocarboxylic acids, styrene and substituted styrenes, acrylic and methacrylic acid and derivatives thereof, e.g. esters of (meth)acrylic acid, (meth)acrylonitriles, and (meth)acrylic anhydrides. Acrylic and methacrylic esters preferably have from 1 to 18 carbon atoms, more preferably from 1 to 12 carbon atoms, in the alkyl chain. The alkyl chain can be linear or branched and can have other functionalities, e.g. amino groups or alcohol groups.

Examples of vinyl monomers are methyl acrylate, ethyl acrylate, n-propyl acrylate, n-butyl acrylate, isobutyl acrylate, sec-butyl acrylate, tert-butyl acrylate, n-hexyl acrylate, ethylhexyl acrylate, isobornyl acrylate, methyl methacrylate, ethyl methacrylate, n-butyl methacrylate, isobutyl methacrylate, tert-butyl methacrylate, n-hexyl methacrylate, isobornyl methacrylate, acrylonitrile, methacrylonitrile, styrene, 1,3-butadiene, 1,2-butadiene, isoprene, vinyl acetate, vinyl propionate, vinyl chloride, vinylidene chloride, acrylic acid, methacrylic acid, acrylamide, methacrylamide, 2-hydroxyethyl acrylate, 2-hydroxyethyl methacrylate, hydroxypropyl acrylate, propylene glycol methacrylate, butanediol monoacrylate, ethyldiglycol acrylate, dimethylaminoethyl acrylate, dimethylaminoethyl methacrylate, N-(3-dimethylaminopropyl)methacrylamide, diethylaminoethyl acrylate, tert-butylaminoethyl methacrylate, 2-chloroacrylonitrile, N-hydroxymethylacrylamide, N-hydroxymethylmethacrylamide, 2-sulfoethyl methacrylate, 2-acrylamido-2-methylpropanesulfonic acid, fumaric acid, maleic acid, crotonic acid, itaconic acid, glycidyl methacrylate, diacetoneacrylamide, diacetonemethacrylamide, acrylamidoglycolic acid, methylacrylamidoglycol methyl ether.

Particularly preferred acrylate monomers are methyl acrylate, butyl acrylate, ethyl acrylate, and ethylhexyl acrylate. A particularly preferred methacrylate monomer is methyl methacrylate (MMA). Also of particular interest are PVC and copolymers of styrene with acrylonitrile (SAN). Styrene can be used as comonomer in order to alter the refractive index of polymer A or polymer B.

The vinyl polymers A and B are preferably selected from the group of the polymers based on dienes, such as isoprene or butadiene, on vinyl halides, such as vinyl chloride, on vinyl esters, such as vinyl acetate and vinyl esters of α-branched monocarboxylic acids, on styrene and substituted styrenes, on acrylic and methacrylic acids, and on derivatives thereof, e.g. esters of (meth)acrylic acid, (meth)acrylonitriles and (meth)acrylic anhydrides. Particularly preferred polymers are polymers of esters of acrylic acid and methacrylic acid.

Vinyl polymer A is preferably a copolymer made of a first monomer with a copolymerization parameter r₁>1 and of a second monomer with a copolymerization parameter r₂<0.8.

In another preferred embodiment, vinyl polymer A is a copolymer comprising units of vinyl acetate or esters of acrylic acid and methacrylic acid, in particular a copolymer based on methyl acrylate, ethyl acrylate, butyl acrylate, and/or ethylhexyl acrylate, very particularly preferably a copolymer of one or more of said monomers with MMA.

Vinyl polymer A is more preferably a butyl acrylate-methyl methacrylate copolymer. The ratio by weight of butyl acrylate units to methyl methacrylate units is preferably in the range from 10:1 to 1:2 in the copolymer A.

Vinyl polymer B is preferably a copolymer made of a first monomer with a copolymerization parameter r₁>1 and of a second monomer with a copolymerization parameter r₂<0.8.

In another preferred embodiment, vinyl polymer B is a polymer based on MMA, in particular in combination with methyl acrylate, ethyl acrylate, butyl acrylate, and/or ethylhexyl acrylate. The ratio by weight of acrylate units to methyl methacrylate units in the copolymer B is preferably in the range from 2:1 to 1:100. It is likewise preferable that the vinyl polymer B comprises subordinate amounts of polar vinyl monomers, e.g. (meth)acrylic acid, (meth)acrylamide, hydroxyethyl (meth)acrylate, and hydroxypropyl (meth)acrylate, e.g. that vinyl polymer B comprises amounts of from 0.1 to 5% by weight, preferably from 0.5 to 2% by weight, of (meth)acrylic acid units. Other vinyl polymers B of interest for some applications are those based on vinyl chloride.

Preferably, the hybrid particle according to the invention comprises at least two vinyl polymers (vinyl polymer A and vinyl polymer B), for example of esters of acrylic acid, esters of methacrylic acid, of styrenes, and/or of vinyl esters, which have glass transition temperatures T_{g} which differ from one another. The glass transition temperature T_{g} of vinyl polymer A is generally in the range from −100° C. to +100° C., preferably in the range from −80° C. to +50° C. In contrast, the glass transition temperature T_{g} (calculated from the Fox equation or measured) of vinyl polymer B is preferably at least 20° C. higher than that of vinyl polymer A.

The expression glass transition temperature T_{g} relates to the glass transition temperature of the polymers present in the hybrid particles according to the invention. The glass transition temperatures of any homopolymers are known and are listed by way of example in J. Brandrup, E. H. Immergut, Polymer Handbook 1st Ed. J. Wiley, New York, 1975. The glass transition temperature of a copolymer can be calculated from the so called Fox equation (T. G. Fox, Bull. Am. Phys. Soc. (Ser. II], 1, 123 [1956]). Glass transition temperatures are usually measured by DSC (Differential Scanning calorimetry) or by DMTA (Dynamic Mechanical Thermal Analysis).

Particular advantages are obtained if vinyl polymer A and vinyl polymer B are at least to some extent compatible with one another, i.e. are at least to some extent miscible with one another. This is the case by way of example for vinyl polymers A and B which have at least one vinyl monomer in common. Examples are copolymers A and B made of methacrylic esters (monomer 1) and of acrylic esters (monomer 2) with copolymerization parameters which are generally r₁>2 and r₂<0.6. An example of copolymers A and B compatible to some extent is a composition of: vinyl polymer A (batch polymerization) having 30% by weight of MMA, and 70% by weight of butyl acrylate; and vinyl polymer B (feed polymerization) having 50% by weight of MMA and 50% by weight of butyl acrylate. For the purposes of the invention, it is preferable that vinyl polymer A and vinyl polymer B interpenetrate one another physically to some extent.

Polymer A preferably forms a polymer network. This polymer A network comprises the nanoscale SiO₂ particles either physically included, and in this case the crosslinking can take place by way of low-molecular-weight conventional crosslinking agents as chemical crosslinking agents, or chemically linked in the form of crosslinking agents. Preference is given to crosslinking by way of methacrylate groups or other polymerizable groups, e.g. methacrylate groups, on the surface of the SiO₂ particles. In this case, it is preferable to use no conventional crosslinking agents.

The expression conventional crosslinking agents denotes low-molecular-weight (preferably monomeric) molecules having at least two polymerizable double bonds which can link initially linear or branched macromolecular networks to yield three-dimensional polymer networks. Conventional crosslinking agents have been defined by way of example in Römpp Chemie-Lexikon [Römpp Chemical Encyclopedia], 10th edition, volume 6, page 4836. Examples of such crosslinking agents are allyl acrylate, allyl methacrylate, ethylene glycol diacrylate, diethylene glycol diacrylate, triethylene glycol diacrylate, tetraethylene glycol diacrylate, butanediol diacrylate, hexanediol diacrylate, neopentyl glycol diacrylate, tri methylolpropane triacrylate, tripropylene glycol diacrylate, tricyclodecanyl diacrylate, tricyclodecanyl dimethacrylate, N,N-methylenebisacrylamide and N,N-methylenebismethacrylamide.

When SiO₂ particles having a crosslinking effect are used, the production of polymer A preferably uses no, or at most a small amount (at most 2% by weight) of conventional crosslinking agent molecules, preferably at most 1% by weight, more preferably at most 0.5% by weight, more preferably at most 0.2% by weight. In a preferred embodiment, the polymerizable bulk comprises no technically relevant amounts of conventional crosslinking agent molecules. The function of crosslinking agent is assumed exclusively by the surface groups of the SiO₂ particles. For the purposes of the invention, it is also possible to use, alongside this, very small amounts of conventional crosslinking agents, preferably of graft-linking agents, such as allyl methacrylate, in order to modify the network.

It is also preferable that the polymer network comprises the nanoscale SiO₂ particles homogeneously distributed, i.e. that the number of SiO₂ particles per unit volume (or in micrographs of sections: per unit area) is substantially identical within those regions of the hybrid particle that comprise vinyl polymer A. Thereby, the dimension of the material examined is generally at least 8 times the size of the SiO₂ particles. Therefore, most of the SiO₂ particles within the network do not form domains. Examples of these domains would be shells consisting of SiO₂ particles around a polymer core which comprises few to no SiO₂ particles, or accumulations of SiO₂ particles surrounded by polymer and having no, or only a few, SiO₂ particles present between them. In accumulations of this type it is also possible that the individual SiO₂ particles are present in non-agglomerated and/or non-aggregated form.

Vinyl polymer A is a generally high-molecular-weight polymer, even without crosslinking. The internodal length from crosslinking point to crosslinking point can be controlled by way of the quantitative ratio of crosslinker molecule to vinyl monomers A, and the chain length can be controlled by way of the amount of initiator. The general rule is: as the amount of crosslinking agent or initiator decreases, the internodal lengths increase or the polymer chains become longer; as the internodal distances increase, the network becomes more extensible.

Vinyl polymer B is capable of crosslinking the hybrid particles according to the invention to one another. This involves chemical and/or physical crosslinking. Crosslinking means the construction of a three-dimensional network (see Römpp Chemie Lexikon [Römpp Chemical Encyclopedia], 9th edition, volume 6 (1992), p. 4898).

When the hybrid particles are crosslinked, a large number of individual particles form bonds to one another by way of the vinyl polymer B yield a network. Examples of this are the formation of a film from a dispersion of the hybrid particles, e.g. via removal of the dispersing agent, or the production of a workpiece from a powder or from a dispersion of individual hybrid particles, e.g. via extrusion.

Examples of chemical crosslinking are the formation of covalent, coordinative, or ionic bonds. In case of the physical crosslinking of the hybrid particles, formation of a network takes place by way of domains within the polymer network. Such domains can be crystalline or amorphous regions below the glass transition temperature. It is preferable that the crosslinking takes place by way of amorphous domains. Physical crosslinking can by way of example be produced by bringing the hybrid particles into immediate contact with one another (e.g. via removal of the water from an aqueous dispersion of the hybrid particles), wherein the polymer chains of vinyl polymers B of various hybrid particles physically interpenetrate one another (for example so called interpenetration networks) thus leading to a stable linkage. A physical crosslinking within the polymer material can be discerned by the presence of a continuous polymer phase which is substantially free of SiO₂ particles and the location of which is between the domains of polymer A comprising SiO₂ particles. Vinyl polymers B preferably suitable for the crosslinking process have good film-forming properties.

The physical and chemical crosslinking of the hybrid particles can be combined. By incorporating reactive groups into vinyl polymer B, it is possible by way of example, to carry out chemical crosslinking additionally after the formation of the material via physical crosslinking. Examples of suitable comonomers in vinyl polymer B are N-methylolacrylamide and N-methylolmethacrylamide, which may be crosslinked by condensation, or (meth)acrylic acid, which may be crosslink by way of salt formation.

Preference is given to physical crosslinking. If the intention is to carry out chemical crosslinking, it is preferable to begin with physical crosslinking.

It is preferable that vinyl polymer B is not crosslinked in the isolated hybrid particle, in particular not chemically crosslinked. Vinyl polymer B preferably is a polymer with a molar mass M_{w} in the range from 10,000 to 5,000,000 g/mol, preferably in the range from 50,000 to 1,000,000 g/mol. It is moreover preferable that at least >30% by weight of vinyl polymer B is of high molar mass (e.g. >50 000 g/mol, preferably >100,000 g/mol) and is not crosslinked. Provided that vinyl polymer B does not penetrate into vinyl polymer A, vinyl polymer B is substantially free of SiO₂ particles.

Chain-transfer agents can be used to adjust the molecular weight of vinyl polymer A and B, in particular of vinyl polymer B, examples being alkanethiols or esters of thioglycolic acid, e.g. 2-ethylhexyl thioglycolate.

In one preferred embodiment, the present invention provides a hybrid particle comprising

a vinyl polymer A which is chemically crosslinked by way of reactively surface-modified, colloidal SiO₂ particles with an average particle size from 1 to 150 nm, and

a vinyl polymer B which is not chemically crosslinked and which is capable of crosslinking hybrid particles with one another, preferably crosslinking them physically.

It is preferable that the ratio by weight of vinyl polymer A to vinyl polymer B is in the range from 10:1 to 1:2, preferably from 5:1 to 1:1, particularly preferably in the range from 3:1 to 1.5:1.

It is preferable that the water absorption of vinyl polymer B is greater than that of vinyl polymer A. It is preferable that vinyl polymer B comprises from 0.1 to 5% by weight of hydrophilic groups, e.g. salts of methacrylic acid and/or hydroxyethyl acrylate and/or adhesion-mediating groups, or hydrophilic moieties from the water-soluble initiators, for example —SO₄H in K₂S₂O₅.

The average particle size of the SiO₂ particles contained in the hybrid particle of the invention is generally from 1 to 150 nm. Preferred lower limits for the average size of the SiO₂ particles are 2 nm, 3 nm, 4 nm, and 5 nm. Preferred upper limits are 100 nm, 75 nm, 50 nm, 30 nm, and 25 nm.

The SiO₂ particle size can be determined in solution by means of dynamic light scattering on a “Dynamic Light Scattering Particle Size Analyzer LB-550” from Horiba company at a concentration of at most 10% by weight of particles, wherein the maximum permissible dynamic viscosity of the dispersion at 25° C. is 3 mPas. The particle size stated is the median (D50 value) of the particle size distribution.

In the solid phase, the SiO₂ particle size can be determined by transmission electron microscopy. For this, at least 100 SiO₂ particles are measured and a particle size distribution is constructed.

The SiO₂ particles are present in colloidal form, i.e. the nanoscale silicon dioxide is generally present as at least 50% of separate, non-aggregated and non-agglomerated primary particles. Unlike aggregates and agglomerates, the primary particles are have spherical shape. Other preferred lower limits are 70%, 80%, 90%, 95%, and 98%. These percentages are % by weight. Therefore, the invention therefore preferably provides a hybrid particle which is substantially free of aggregates and/or agglomerates of the SiO₂ particles.

The SiO₂ particles can be surface-modified or non-surface-modified particles. Preference is given to SiO₂ particles, which are surface-modified by way of example with reactive or unreactive groups. Particular preference is given to surface-functionalized SiO₂ particles which bear polymerizable groups as reactive groups on the surface. The polymerizable groups on the surface of the SiO₂ particles can in particular comprise vinyl groups, allyl groups, hexenyl groups, acryloyl groups, and/or methacryloyl groups.

For the surface modification, the corresponding groups can by way of example be bound chemically to the surface of the SiO₂ particles via suitable silanization. Suitable silanes are preferably those selected from the group consisting of organosilanes of the formula R¹ₐSiX₄₋ₐ, organosilanes of the formula (R¹₃Si)_{b}NR¹_{3-b}, and organosiloxanes of the formula R¹ₙSiO_{(4-n)/2}, in which each R¹ independently of the other ones selected from hydrocarbon moieties having from 1 to 18 carbon atoms or from organofunctional hydrocarbon moieties having from 1 to 18 carbon atoms, or is a hydrogen atom, each X is selected independently of the other ones and is a hydrolyzable group, a=0, 1, 2, or 3, b=1, 2, or 3, and n is a number from 2 to, and inclusive of, 3. Examples of hydrolyzable groups are halogen, alkoxy, alkenoxy, acyloxy, oximino, and aminoxy groups.

Examples of functional, nonhydrolyzable groups are vinyl, aminopropyl, chloropropyl, aminoethylaminopropyl, glycidyloxypropyl, mercaptopropyl, or methacryloxypropyl groups. Suitable are by way of example alkoxysilanes, silazanes, and halosilanes. Examples that may be mentioned of silanes which can be used to bind polymerizable groups to the surface of the SiO₂ particles are vinyltrimethoxysilane, vinyltriethoxysilane, methylvinyldimethoxysilane, methylvinyldiethoxysilane, vinyldimethylmethoxysilane, vinyldimethylethoxysilane, divinyldimethoxysilane, divinyldiethoxysilane, vinyltriacetoxysilane, vinyltrichlorosilane, methylvinyldichlorosilane, dimethylvinylchlorosilane, divinyldichlorosilane, vinyltris(2-methoxyethoxy)silane, hexenyltrimethoxysilane, 3-methacryloxypropyltrimethoxysilane, 3-methacryloxypropyltriethoxysilane, 3-methacryloxypropyltriacetoxysilane, methacryloxymethyltrimethoxysilane, methacryloxymethyltriethoxysilane, (methacryloxymethyl)methyldimethoxysilane, (methacryloxymethyl)methyldiethoxysilane, acryloxypropyltrimethoxysilane, acryloxypropyltriethoxysilane, 3-methacryloxypropyltrichlorosilane, 3-methacryloxypropyldimethylchlorosilane, vinylbenzylethylenediaminopropyltrimethoxysilane, vinylbenzylethylenediaminopropyltrimethoxysilane hydrochloride, allylethylenediaminopropyltrimethoxysilane, allylethylenediaminopropyltriethoxysilane, allyltrichlorosilane, allylmethyldichlorosilane, allyldimethylchlorosilane, allyltrimethoxysilane, allyltriethoxysilane, allylmethyldimethoxysilane, allylmethyldiethoxysilane, allyldimethylmethoxysilane, allyldimethylethoxysilane, divinyltetramethyldisilazane, divinyltetramethyldisiloxane, trimethyltrivinylcyclotrisiloxane, tetramethyltetravinylcyclotetrasiloxane, pentamethylpentavinylcyclopentasiloxane, and hexamethylhexavinylcyclohexasiloxane. An example that may be mentioned of silanes which can be used to modify the surface is phenyltrimethoxysilane, phenyltriethoxysilane, propyltrimethoxysilane, propyltriethoxysilane, 3-glycidyloxypropyltrimethoxysilane, hexamethyldisiloxane, hexamethyldisilazane, 3-aminopropyltrimethoxysilane, 3-aminopropylmethyldiethoxysilane, 3-aminopropyldimethylmethoxysilane, chloropropyltrimethoxysilane, chlorotrimethylsilane, dimethylchlorosilane, methyltrimethoxysilane, trimethylmethoxysilane, methylhydrodimethoxysilane, dimethyldimethoxysilane, ethyltrimethoxysilane, ethyltriacetoxysilane, propyltrimethoxysilane, diisopropyldimethoxysilane, diisobutyldimethoxysilane, chloropropyltrimethoxysilane, chloropropylmethyldimethoxysilane, chloroisobutylmethyldimethoxysilane, trifluoropropyltrimethoxysilane, trifluoropropylmethyldimethoxysilane, isobutyltrimethoxysilane, n-butyltrimethoxysilane, n-butylmethyldimethoxysilane, phenyltrimethoxysilane, phenyltrimethoxysilane, phenylmethyldimethoxysilane, triphenylsilanol, n-hexyltrimethoxysilane, n-octyltrimethoxysilane, isooctyltrimethoxysilane, decyltrimethoxysilane, hexadecyltrimethoxysilane, cyclohexylmethyldimethoxysilane, cyclohexylethyldimethoxysilane, dicyclopentyldimethoxysilane, tert-butylethyldimethoxysilane, tert-butylpropyldimethoxysilane, dicyclohexyldimethoxysilane, mercaptopropyltrimethoxysilane, bis(triethoxysilylpropyl)disulfide, bis(triethoxysilylpropyl)tetrasulfide, mercaptopropylmethyldimethoxysilane, aminopropyltrimethoxysilane, m-aminophenyltrimethoxysilane, aminopropylmethyldiethoxysilane, phenylaminopropyltrimethoxysilane, aminoethylaminopropyltrimethoxysilane, aminoethylaminopropylmethyldimethoxysilane, glycidoxypropyltrimethoxysilane, glycidoxypropylmethyldimethoxysilane, epoxycyclohexylethyltrimethoxysilane.

The production of silanized SiO₂ particles having polymerizable groups on the surface is in principle already known in the prior art. By way of example, SiO₂ particles can be precipitated from silica sols and then silanized with organosilanes, for example vinylsilanes. This type of production process by way of precipitated silicas is described by way of example in EP 0 926 170 B1. Other examples are found in EP 1 366 112, EP 2 025 722, EP 08007625, EP 08007580, EP 08007581, and EP 08007582. Another possibility is described in J. Colloid Interface Sci 26:62 (1968). This is the so called Stöber synthesis of such nanoparticles.

The polymerizable groups on the surface of the SiO₂ particles can in particular comprise vinyl groups, allyl groups, hexenyl groups, acryloyl groups, and/or methacryloyl groups.

SiO₂ particles surface-functionalized with polymerizable groups act as crosslinking agents during the production of the vinyl polymer A and bring about a chemical crosslinking.

For the purposes of the invention, it is also possible to use SiO₂ particles which do not bring about any crosslinking, for example SiO₂ particles surface-modified with unreactive groups. In these cases, it is preferable to use conventional crosslinking agent molecules during the production of vinyl polymer A.

In another variant of the invention, at least two different polymerizable groups are arranged on the surface of the SiO₂ particles. The different polymerizable groups can preferably be methacryloyl, acryloyl, styryl, or itaconyl groups on the one hand, and vinyl, allyl, alkenyl, or crotonyl groups on the other hand. They can also comprise in particular acryloyl and/or methacryloyl groups on the one handand vinyl, hexenyl, and/or allyl groups on the other hand.

To produce this type of dual surface modification, the corresponding silanes and siloxanes, respectively, can be reacted in a mixture or in succession during the silanization of the SiO₂ particles.

The surface coverage of the SiO₂ particles with polymerizable groups is preferably from 0.01 to 6 groups/nm², more preferably from 0.02 to 4 groups/nm².

SiO₂ particles surface-functionalized with reactive, e.g. polymerizable, groups can act as crosslinking agents during the production of the vinyl polymer A, and can bring about chemical crosslinking. For the purposes of the invention, it is also possible to use SiO₂ particles which do not bring about any crosslinking, for example unmodified SiO₂ particles, or SiO₂ particles, surface-modified with unreactive groups. In these cases, it is preferable to use conventional crosslinking agents during the production of vinyl polymer A.

Besides the polymerizable groups, the SiO₂ particles can also bear groups which do not react in a polymerization. In particular, the modification of the SiO₂ particles should be such that in a 2-phase system, e.g. butyl acrylate-water, the particles remain in the butyl acrylate phase and do not agglomerate.

The surface area of the SiO₂ particles can be calculated from the particle size in the case of spherical particles. For calculation, the median of the particle size distribution (D50) is used. The specific surface area (A₀) can then be calculated by using the density of the particle (ρ):

A₀=6/(ρ×D50)

The density of colloidal silicon dioxide is 2.1 g/cm³.

The number of reactive groups per unit of surface area (n_{R}^{A}) is calculated from the quotient derived from the number of reactive groups (n_{R}^{M}) per unit of mass divided by the specific surface area:

n_{R}=(n_{R}^{M}/A₀)

The number of reactive groups per unit of mass n_{R}^{M} can be determined by way of suitable analytical methods. If silanes of alkoxy, acyloxy, acetoxy, alkenoxy or oximosilane type are used in order to introduce the reactive groups onto the surface, a complete hydrolysis of the silane can be assumed. That means that all of the groups used are in turn found on the surface of the SiO₂ particles.

The number of polymerizable groups on the surface of the SiO₂ particle can also be determined by NMR spectroscopy or by means of DSC (differential scanning calorimetry). These methods can in particular be used when there are no suitable analytical methods available to determine reactive groups (for example determination of iodine number in the case of vinyl groups). In the case of DSC, the heat of polymerization is measured as a measure of the number of polymerizable groups on the surface of the SiO₂ particle. For said DSC determination, a defined amount of the surface-modified SiO₂ particles is treated with a standardized peroxide solution, and the heat of reaction is measured. The method is described by way of example in DE 36 32 215 A1.

The average size of the hybrid particles according to the invention is generally from 100 to 5000 nm, preferably 150 to 2000 nm, more preferably from 200 to 1500 nm, and their shape is substantially spherical. D50/(D90−D10) for the particle size distribution of the hybrid particles is preferably >2.

The preferred hybrid particles have a central region which essentially consists of vinyl polymer A and of SiO₂ particles. Thereby, the SiO₂ particles substantially have a homogenous distribution in vinyl polymer A. The outer regions of the preferred hybrid particles essentially consist of vinyl polymer B and are substantially free of SiO₂ particles. Thereby, vinyl polymer B can by way of example form a shell around vinyl polymer A, or can be arranged in some other shape, e.g. a “raspberry” structure, around vinyl polymer A, too. Vinyl polymer B can penetrate to some extent into vinyl polymer A, thus giving regions, in particular in the marginal region of the central region formed by vinyl polymer A, in which both vinyl polymers are present next to one another. A subsequent (preferably physical) crosslinking of the hybrid particles by way of vinyl polymer B thus produces a particularly strong bond.

A hybrid particle generally comprises at least 10 SiO₂ particles, preferably at least 25 SiO₂ particles, particularly preferably 50 SiO₂ particles. The content of SiO₂ particles is from 1 to 40% by weight, preferably from 1 to 30% by weight, more preferably from 1 to 15% by weight, particularly preferably from 2 to 8% by weight.

The hybrid particle can also comprise, alongside the abovementioned constituents, other components, e.g. UV stabilizers, antioxidants, lubricants, separating agents, tackifiers, adhesion promoters, leveling agents, solvents, or dyes soluble in organic substances, preferably in concentrations of between 0 and 5% by weight, particularly preferably 0.01 to 1% by weight, based on the total weight of the hybrid particle.

The hybrid particles have particularly good mechanical properties. The hybrid particles do not only have particularly high tensile strength and tensile strain at break but also excellent resilience. Moreover, the properties of the hybrid particles can be adjusted over a wide range.

One form of application of the hybrid particles is the aqueous dispersion. Said dispersion is likewise subject of the present invention. Dispersions having a content of hybrid particles of from 20 to 70% by weight, preferably from 30 to 65% by weight, particularly preferably from 40 to 60% by weight, based in each case on the total weight of the dispersion, are customary. The dispersion generally comprises emulsifiers, e.g. anionic, cationic, amphoteric, or nonionic emulsifiers. Preference is given to anionic and non-ionic emulsifiers, and particular preference is given to anionic emulsifiers. Anionic emulsifiers include the sodium, potassium, and ammonium salts of fatty acids and sulfonic acids; the alkali metal salts of C₁₂-C₁₆-alkyl sulfates; ethoxylated and sulfated or sulfonated fatty alcohols; alkylphenols and sulfodicarboxylate esters. Nonionic emulsifiers include ethoxylated fatty alcohols and alkylphenols having from 2-150 ethylene oxide units per molecule. Cationic emulsifiers include ammonium, phosphonium, and sulfonium compounds having a hydrophobic moiety which by way of example is composed of one or more long alkyl chains. Preferred emulsifiers are alkylbenzenesulfonates, dialkyl sulfosuccinates, Na C₁₄-C₁₆-akylsulfonates salt, and Na dodecyl sulfate salt. The emulsifiers produced via ethoxylation and sulfation of alkylphenols have particularly good suitability. Examples are the derivatives of nonylphenol or triisobutylphenol having from 5 to 10 ethylene oxide units, e.g. 6-fold-ethoxylated triisobutylphenol, sulfated Na salt. In addition, the dispersion can also comprise protective colloids, dyes, separating agents, lubricants, stabilizers (antioxidant, UV), solvents, leveling agents, adhesion promoters, tackifiers and preservatives.

The hybrid particle can also be used as thermoplastically processable elastomers, known as TPEs. The hybrid particles can by way of example be processed in an injection-molding process to give elastomeric bodies. A feature of the moldings produced here is not only good mechanical properties but also particularly pleasant haptics. Another advantage of TPEs is their capability to be recycled.

The hybrid particles can also be used as coating agents. Thereby, the hybrid particles form a film which does not only comprise (color) pigments but also additives typical of paints and coatings, e.g. UV stabilizers, antioxidants, leveling agents, deaerating agents, adhesion promoters, and surfactants.

The hybrid particles can also be used in adhesives. Thereby, the hybrid particles can function as binders and do not comprise inorganic fillers but also adhesion promoters and other additives typical of adhesives.

The hybrid particles can also be used in coating formulations based on (meth)acrylates in order to improve toughness, haptics, and sliding properties and frictional properties.

The hybrid particles can improve the mechanical properties in potting compositions, e.g. those based on epoxy or on cyanate ester.

The hybrid particles can also be used in sealants for the construction sector. Thereby, the following can be used alongside the hybrid particles: fillers, pigments, other polymers, UV stabilizers and antioxidants, adhesion promoters, and other components typical of sealants.

The hybrid particles can also be used as sealant material. The hybrid particles cannot only have good mechanical properties but also good resistance to oil and to solvents.

### Production Process

The hybrid particles of the invention can by way of example be produced via a two-stage polymerization process which is also a subject of the present invention. Preference is given to a production process in which, in a first polymerization stage, one or more vinyl monomer(s) is/are polymerized in the presence of the nanoscale SiO₂ particles in a water-insoluble phase. The SiO₂ particles are in dispersed form in the water-insoluble phase. The water-insoluble phase used in the polymerization process can optionally also comprise organic solvents and other components, such as initiators or emulsifiers, alongside vinyl monomers and SiO₂ particles. In one embodiment, the water-insoluble phase substantially consists of vinyl monomer or of a mixture of vinyl monomer and of organic solvent. It is preferable that the water-insoluble phase substantially consists of vinyl monomer.

In a second polymerization stage, vinyl monomers are polymerized in an aqueous-medium phase in the presence of the polymer obtained in the first polymerization stage. The polymerization mixture can optionally also comprise other components, such as organic solvents, initiators, or emulsifiers, alongside the polymer from the first polymerization stage and vinyl monomer.

Both polymerization stages are carried out in a two-phase system made of water and of a water-insoluble phase, and it is preferable to use emulsifiers for this purpose. The polymerizations preferably proceed by a free-radical mechanism, therefore, it is optionally possible to use appropriate initiators, too. Chain-transfer agents can be used to adjust molecular weight in polymerization step 1 and 2, in particular in polymerization step 2, examples being alkanethiols or esters of thioglycolic acid, e.g. 2-ethylhexyl thioglycolate.

Examples of organic solvents that can be used are ketones, aldehydes, alcohols, esters, ethers, aliphatic, aromatic, and halogenated hydrocarbons, and also plasticizers. In one embodiment, the solvent is selected such that it is easy to remove at the end of the process. Preference is given to methanol, ethanol, isopropanol, toluene, xylene, pentane, hexane, heptane, octane, ethyl acetate, isopropyl acetate, butyl acetate, acetone, methyl ethyl ketone, methyl isobutyl ketone, and methoxypropanol. In another embodiment, the solvent is a long-chain alcohol, which can remain in the hybrid particle.

The first polymerization stage is preferably a suspension polymerization, particularly preferably a microsuspension. By way of example, the vinyl monomers, a monomer-soluble initiator, and the SiO₂ particles can be suspended in water and polymerized. Emulsification preferably takes place by using of an emulsifier and under the action of high shear forces, for example via a high-speed mixer. Once emulsification is complete, stirring can be continued at the same rate or preferably at a slower rate. The polymerization is generally carried out at a temperature from 20 to 150° C., preferably in the range from 30 to 100° C., particularly preferably between 50 to 90° C., e.g. as feed polymerization or batch polymerization. Batch polymerization is preferred.

It is preferable that prior to and during the polymerization the SiO₂ particles are dispersed in a water-insoluble phase, e.g. organic solvent and/or vinyl monomer, wherein it is particularly preferable that the SiO₂ particles are dispersed in vinyl monomer.

In a preferred embodiment, a water-insoluble phase composed of the vinyl monomers of the first stage, the colloidal SiO₂ particles and of an initiator soluble in said monomers is emulsified with water by means of an emulsifier, under the action of high shear forces to give a fine-particle oil-in-water emulsion and is. The size of the oil droplets is generally in the range from 100 to 5000 nm, preferably from 150 to 2000 nm, particularly preferably between 200 and 1500 nm, for example about 0.5 μm. Thereby, the SiO₂ particles are present in the water-insoluble phase. The resultant emulsion is brought to polymerization temperature and polymerized under the action of only small shear forces. Thereby, the polymerization temperature is generally in the range from 20 to 150° C., preferably in the range from 30 to 100° C., particularly preferably between 50 and 90° C.

The choice of the monomer-soluble initiator here depends on the polymerization temperature selected and on the monomers used. Preference is given to initiators that decompose thermally, e.g. organic peroxides and azo compounds, e.g. perketals, peroxides, and peresters:

tert-butyl peroxypivalate τ_{1/2}=1 h at 74° C.

tert-butyl peroxy-2-ethylhexanoate τ_{1/2}=1 h at 92° C.

dilauroyl peroxide τ_{1/2}=1 h at 80° C.

An example of an azo compound is azobisisobutyronitrile (AIBN).

Preference is given by way of example to polymerization of the 1^{st} stage with dilauroyl peroxide as initiator and with (meth)acrylate esters at about 80° C. Polymerization is carried out at elevated pressure in particular when gaseous monomers are used.

Examples of emulsifiers that can be used are anionic, cationic, amphoteric, and nonionic emulsifiers. Preference is given to anionic and nonionic emulsifiers, and particular preference is given to anionic emulsifiers. Anionic emulsifiers include the sodium, potassium, and ammonium salts of fatty acids and sulfonic acids; the alkali metal salts of C₁₂-C₁₆-alkyl sulfates; ethoxylated and sulfated or sulfonated fatty alcohols; alkylphenols and sulfodicarboxylate esters. Nonionic emulsifiers include ethoxylated fatty alcohols and alkylphenols having 2-150 ethylene oxide units per molecule. Cationic emulsifiers include ammonium, phosphonium, and sulfonium compounds having a hydrophobic moiety which by way of example is composed of one or more long alkyl chains. Preferred emulsifiers are alkylbenzenesulfonates, dialkyl sulfosuccinates, Na C₁₄-C₁₆-alkylsulfonates salt, and Na dodecyl sulfate salt. The emulsifiers produced via ethoxylation and sulfation of alkylphenols have particularly good suitability. Examples are the derivatives of nonylphenol or triisobutylphenol having from 5 to 10 ethylene oxide units, e.g. 6-fold-ethoxylated triisobutylphenol, sulfated Na salt. The emulsifiers are typically used in concentrations between 0.02 and 5% by weight, preferably from 0.1 to 2% by weight, based on the vinyl monomers.

In the first polymerization stage generally a suspension is obtained which comprises polymer particles suspended in water and SiO₂ particles comprised therein. The vinyl polymer obtained in the first polymerization stage is then used in the second polymerization stage. Thereby, the polymerization mixture obtained in the first stage preferably is subjected directly to further use, e.g. by adding the components of the second polymerization stage directly to the reaction vessel in which the polymerization mixture of the first polymerization stage is present.

In one embodiment, the polymer of the first polymerization stage thereby forms a water-insoluble phase, the latter can optionally also comprise organic solvents and other components, such as initiators or emulsifiers, alongside monomer of the second stage.

In one preferred embodiment, the second polymerization stage is an emulsion polymerization. By way of example, an aqueous emulsion which contains the vinyl monomers, an emulsifier, and optionally a water-soluble initiator can be added to the polymer obtained in the first polymerization state. The polymerization can take place in form of feed polymerization (semicontinuous polymerization) or of batch polymerization, wherein single or multiple batchwise addition is possible. Preference is given to a feed polymerization.

In another embodiment, an emulsion which can be produced from the vinyl monomers, from water, from water-soluble initiator, and from emulsifier, under the action of high shear forces, is added at polymerization temperature to the suspension obtained in the first polymerization step. The feed is preferably controlled in such a way that in each case only small amounts of vinyl monomer are present in the reaction mixture, i.e as so called feed polymerization.

In another embodiment, the vinyl monomers of the second polymerization stage are metered, without further initiator, into the polymerization mixture present in the reaction vessel and deriving from the first polymerization stage, and are polymerized in the presence of residual initiator still present from the first polymerization stage. It can also be advantageous to begin the addition of the vinyl monomers of the second polymerization stage when only 80 to 95% by weight of the vinyl monomers of the first polymerization stage have been polymerized.

If initiator is added for the second polymerization stage, a water-soluble initiator is generally used for this purpose. Examples of water-soluble initiators are alkali metal persulfates, ammonium persulfate, and hydrogen peroxide. Preference is given to the use of peroxodisulfates as initiator, an example being potassium peroxodisulfate. Redox initiators can also be used. These comprise alongside an oxidizing component, e.g. ammonium peroxodisulfate, a reducing component, such as e.g. bisulfite, Rongalit, or tertiary aromatic amines. The amount of initiator is preferably in the range from 0.01 to 2% by weight, based on the vinyl monomers.

Examples of emulsifiers that can be used for the second polymerization stage are anionic, cationic, amphoteric or nonionic emulsifiers. Preference is given to anionic and nonionic emulsifiers, and particular preference is given to anionic emulsifiers. If anionic or nonionic emulsifiers are used in the first polymerization stage, it is particularly preferable that anionic or nonionic emulsifiers are also used in the second polymerization stage. It is further preferable to use the same class of emulsifier as in the first polymerization stage. Preferred emulsifiers are alkylbenzenesulfonates, dialkyl sulfosuccinates, C₁₄-alkylsulfonates Na salt, dodecyl sulfate Na salt. The emulsifiers produced via ethoxylation and sulfation of alkylphenols have particularly good suitability. Examples are the derivatives of nonylphenol or triisobutylphenol having from 5 to 10 ethylene oxide units, e.g. 6-fold-ethoxylated triisobutylphenol, sulfated Na salt. The emulsifiers are typically used in concentrations between 0.02 and 5% by weight, preferably between 0.1 and 2% by weight, based on the vinyl monomers.

If in the first polymerization stage anionic or nonionic emulsifiers are udes, it is particularly preferable that anionic or nonionic emulsifiers are also used in the second polymerization stage. It is particularly preferable to use the same class of emulsifier in the second polymerization stage as in the first polymerization stage, e.g. anionic emulsifiers in both stages.

The temperature at which the polymerization of the second polymerization stage is carried out is generally from 20 to 150° C., preferably in the range from 30 to 100° C., particularly preferably between 50 and 90° C. Polymerization is carried out at elevated pressure in particular when gaseous monomers are used.

### Dispersion

The method according to the invention is suitable for obtaining an aqueous dispersion of the hybrid particles. It is preferable that, if the resultant dispersions comprise any coagulate at all, the amounts thereof are only small, preferably less than 1% by weight, particularly preferably less than 0.1% by weight. The dispersion obtained via the method according to the invention can then optionally be subjected to common purification steps, e.g. filtration. The present invention therefore further provides an aqueous dispersion comprising from 20 to 70% by weight, preferably from 30 to 65% by weight, particularly preferably from 40 to 60% by weight, of hybrid particles according to the invention.

The dispersion according to the invention can comprise further components, e.g. polymers or surfactants, emulsifiers, pigments, inorganic fillers, dyes, stabilizers (UV, antioxidant), leveling agents, deaerating agents, preservatives, protective colloids, and further typical additives as used in dispersions. These can be added in the production process according to the invention or subsequently, in particular after a possible purification step.

The dispersion according to the invention exhibits various advantageous properties, e.g. an favorable film-formation temperature, which is generally in the range below 30° C., preferably below 20° C.

The dispersion according to the invention is suitable for various applications, e.g. as adhesive, for example for steel, for aluminum, for glass, for plastics (PVC, PE, PP, polyurethanes) for construction materials (plasterboard), for stone, for leather, for rubbers, for glass-fiber composites, or for carbon fiber composites, or as sealant, e.g. in the construction industry or in the D.I.Y. sector. Another application is provided by coatings.

### Polymeric Material

The present invention further provides a polymeric material which can be obtained by removing the water from the dispersion according to the invention. This can be achieved easily by drying to concentrate the dispersion, e.g. by drying at room temperature or at an elevated temperature. It is preferable to dry the material at between 20 and 80° C. Residual water can be removed by way of example by tempering, for example at temperatures from 80 to 140° C., preferably from 100 to 130° C. It is also possible to dry at reduced pressure. Another option for producing the polymeric material, is to compress the dispersion according to the invention in an extruder, for example as described in DE 44 17 559. Thereby, the dispersion is separated in an extruder to give an aqueous phase and a polymer melt. This results in a particularly pure product since all of the auxiliaries dissolved in water are removed with the aqueous phase. Another option for producing the polymeric material, is to coagulate the dispersion according to the invention, e.g. by common coagulation processes, such as freeze coagulation or chemical coagulation, e.g. using polyvalent ions, such as aluminum ions. Spray drying of the dispersion is equally possible.

The polymeric material according to the invention comprises the hybrid particles in crosslinked, preferably physically crosslinked, form. Physical crosslinking means that a solid phase is built without the formation of chemical bonds. Thereby, It is preferred here that the vinyl polymer B forms a phase which is substantially continuous between the phases of the vinyl polymer A. The regions of the hybrid particles composed of vinyl polymer A and of SiO₂ particles are therefore embedded into a continuous phase made of polymer B. Said continuous phase is substantially free from SiO₂ particles. Preferably, the average distance between the regions comprising vinyl polymer A and SiO₂ particles in the material is from 20 to 250 nm.

After removal of the water, the hybrid particles are generally in a form that can be further processed, e.g. as powder or granulate. Said powder or granulate can be used to produce polymeric moldings, such as films, boards, and components, by further processing.

The polymeric material according to the invention has various advantageous properties such as favorable tensile strain at break which is generally >200%, preferably >300%, tensile strength which is generally >4 MPa, preferably >5 MPa, an E-modulus between 0.3 and 3 MPa, and a Shore hardness between 20 and 90 Shore A.

The polymeric material can be used for various applications, e.g. as thermoplastic elastomer, as gasket, as foil, as adhesive foil, as material for components, and as carrier film.

### EXAMPLES

The invention is explained below by some examples according to the invention, but having no limiting effect at all. First, the test methods used subsequently will first be described.

The solids content of the dispersion was determined by measuring the mass difference prior to and after drying for 2 hours at 120° C.

Tensile properties (tensile strain at break, tensile strength, E-modulus of elasticity (at 100% tensile strain)) were determined by a method using test specimens based on DIN 53504/ISO 37 (S2) in a tensile tester from Zwick company. The test velocity was 200 mm/min.

For evaluation, at least 3 test specimens were tested, and the average value was calculated.

Shore Hardness was Determined in Accordance with DIN 53505.

Glass transition temperatures Tg were determined by DMTA in a Haake Mars II rheometer with low-temperature device and solids clamp. Torsion was introduced into the system with constant amplitude (depending on material and on specimen thickness but in the linear viscoelastic region) with a frequency of 1 Hz.

SiO₂ particle size was determined in the liquid phase by means of dynamic light scattering in a “Dynamic Light Scattering Particle Size Analyzer LB-550” from Horiba company at a concentration of 10% by weight maximum of particles, the dynamic viscosity of the dispersion being <3 mPas at 25° C. The particle size stated is the median (D50 value) of the particle size distribution.

### Example 1

A fine-particle emulsion is produced in an UltraTurrax from 0.43 g of dilauroyl peroxide, 46 g of butyl acrylate, 25 g of dispersion of colloidal SiO₂ particles (30% by weight in butyl acrylate, spherical 25 nm particles, agglomerate-free, surface unreactively modified, no double bonds on the surface), 0.5 g of allyl methacrylate, 0.3 g of sodium salts of C₁₄-C₁₆-alkanesulfonic acids, and 58 g of water, by emulsification for 15 s at 24,000 rpm.

The resultant emulsion is then transferred into a reactor comprising an aqueous phase which is heated to 80° C. and made of 0.1 g of the abovementioned emulsifier in 150 g of water, and is stirred slowly at 80° C. under inert gas. The polymerization is complete after 1 h. Then, an emulsion composed of 0.44 g of methacrylic acid, 21.2 g of MMA, 21.2 g of butyl acrylate, 0.075 g of potassium peroxodisulfate, 0.04 g of sodium salts of C₁₄-C₁₆-alkanesulfonic acids, and 30.5 g of water, produced by emulsification for 15 s at 24,000 rpm in an UltraTurrax is added dropwise within 1 h. Stirring is then continued at 80° C. for 1 h, and the mixture is neutralized by addition of 0.4 g of 25% ammonia solution. Cooling and filtration results in stable aqueous dispersion with a solids content of 31%. The size of the resultant hybrid particles is about 1 μm. The dispersion has film-forming properties at room temperature.

To produce films, the dispersion was poured into a dish and dried at room temperature for 5 days. The films were tempered at 120° C. for 2 hours and exhibit the following mechanical properties:

| | |
|---|---|
| Tensile strength [MPa] | 5.69 |
| Tensile strain at break [%] | 386 |
| E-modulus [MPa] | 0.34 |
| Shore A hardness | 62 |

### Example 2

A fine-particle emulsion is produced in an UltraTurrax from 0.44 g of dilauroyl peroxide, 46 g of butyl acrylate, 25 g of dispersion of colloidal SiO₂ particles (30% by weight in butyl acrylate, spherical 25 nm particles, agglomerate-free, surface reactively modified with 3-methacryloxypropyltrimethoxysilane), 0.3 g of sodium salts of C₁₄-C₁₆-alkanesulfonic acids, and 58 g of water, by emulsification for 15 s at 24,000 rpm.

The resultant emulsion is then transferred into a reactor comprising an aqueous phase which has been heated to 80° C. and is made of 0.1 g of the abovementioned emulsifier in 150 g of water, and is stirred slowly at 80° C. under inert gas. The polymerization is complete after 1 h. Then, an emulsion composed of 0.44 g of methacrylic acid, 21.2 g of MMA, 21.2 g of butyl acrylate, 0.075 g of potassium peroxodisulfate, 0.04 g of sodium salts of C₁₄-C₁₆-alkanesulfonic acids, and 30.5 g of water, produced by emulsification for 15 s at 24,000 rpm in an UltraTurrax is added dropwise within 1 h. Stirring is then continued at 80° C. for 1 h, and the mixture is neutralized by addition of 0.4 g of 25% ammonia solution. Cooling and filtration results in a stable aqueous dispersion with a solids content of 31%. The size of the resultant hybrid particles is about 0.5 μm. The dispersion has film-forming properties at room temperature.

To produce films, the dispersion was poured into a dish and dried at room temperature for 5 days. The films were tempered at 120° C. for 2 hours and exhibit the following mechanical properties:

| | |
|---|---|
| Tensile strength [MPa] | 6.04 |
| Tensile strain at break [%] | 403 |
| E-modulus [MPa] | 0.54 |
| Shore A hardness | 50 |

### Example 3

A fine-particle emulsion is produced from 2.15 g of dilauroyl peroxide, 77.42 g of MMA, 115.48 g of butyl acrylate, 163.6 g of dispersion of colloidal SiO₂ particles (30% by weight in butyl acrylate, spherical 25 nm particles, agglomerate-free, surface reactively modified with 3-methacryloxypropyltrimethoxysilane), 1.6 g of sodium salts of C₁₄-C₁₆-alkanesulfonic acids, and 282.5 g of water, by emulsification (60 s at 24,000 rpm in an UltraTurrax). This emulsion is added to an initial charge of 750 g of water and 0.5 g of sodium salts of C₁₄-C₁₆-alkanesulfonic acids which has been preheated to 80° C., and polymerized at 80° C. within 60 min, under slow stirring. An emulsion produced from 2.15 g of methacrylic acid, 106 g of MMA, 106 g of butyl acrylate, 0.2 g of sodium salts of C₁₄-C₁₆-alkanesulfonic acids, 0.25 g of potassium peroxodisulfate, and 152.5 g of water is then immediately added to the mixture at 80° C. and within 90 min. Stirring is then continued at 80° C. for 1 h. Finally, the dispersion is neutralized by addition of 2 g of 25% ammonia solution. This results in an aqueous dispersion with a solids content of 32%. The dispersion has film-forming properties at room temperature.

To produce films, the dispersion was poured into a dish and dried at room temperature for 5 days. In part, the properties of the resultant films were tested directly, and in part the films were tempered for 2 hours at 120° C. prior to testing. The films exhibit two glass transition temperatures and the following mechanical properties:

| | Without tempering | With tempering |
|---|---|---|
| Tensile strength [MPa] | 8.0 | 7.8 |
| Tensile strain at break [%] | 382 | 397 |
| E-modulus [MPa] | 0.60 | 0.53 |
| Shore A hardness | 41 | 37 |
| T_{g} 1 [° C.] | −2.2 | −1.5 |
| T_{g} 2 [° C.] | 37.5 | 37.8 |

### Example 4

A fine-particle emulsion is produced in an UltraTurrax from 2.15 g of dilauroyl peroxide, 77.42 g of MMA, 115.48 g of butyl acrylate, 163.6 g of dispersion of colloidal SiO₂ particles (30% by weight in butyl acrylate, spherical 25 nm particles, agglomerate-free, surface reactively modified with 3-methacryloxypropyltrimethoxysilane), 1.6 g of sodium salts of C₁₄-C₁₆-alkanesulfonic acids, and 282.5 g of water, by emulsification for 60 s at 24,000 rpm. This emulsion is added to an initial charge of 400 g of water and 0.5 g of sodium salts of C₁₄-C₁₆-alkanesulfonic acids, and polymerized at 80° C. within 60 min resulting in a microsuspension. An emulsion produced from 2.15 g of methacrylic acid, 106 g of MMA, 106 g of butyl acrylate, 0.2 g of sodium salts of C₁₄-C₁₆-alkanesulfonic acids, 0.25 g of potassium peroxodisulfate, and 152.5 g of water is then immediately added to the mixture at 80° C. and within 90 min. Stirring is then continued at 80° C. for 1 h. Finally, the dispersion is neutralized by addition of 2 g of 25% ammonia solution. This results in an aqueous dispersion with a solids content of 40.3%. The dispersion has film-forming properties at room temperature.

To produce films, the dispersion was poured into a dish and dried at room temperature for 5 days. The films exhibit the following mechanical properties:

| | |
|---|---|
| Tensile strength [MPa] | 6.1 |
| Tensile strain at break [%] | 382 |
| E-modulus [MPa] | 0.43 |
| Shore A hardness | 34 |

### Example 5

A fine-particle emulsion is produced from 2.15 g of dilauroyl peroxide, 153.76 g of MMA, 39.24 g of butyl acrylate, 163.60 g of dispersion of colloidal SiO₂ particles (30% by weight in butyl acrylate, spherical 25 nm particles, agglomerate-free, surface reactively modified with 3-methacryloxypropyltrimethoxysilane), 1.6 g of sodium salts of C₁₄-C₁₆-alkanesulfonic acids, and 282.5 g of water, by emulsification (60 s at 24,000 rpm in an UltraTurrax). This emulsion is added to an initial charge of 750 g of water and 0.5 g of sodium salts of C₁₄-C₁₆-alkanesulfonic acids, and polymerized at 80° C. within 60 min resulting in a microsuspension. An emulsion produced from 2.19 g of methacrylic acid, 106 g of MMA, 106 g of butyl acrylate, 0.2 g of sodium salts of C₁₄-C₁₅-alkanesulfonic acids, 0.25 g of potassium peroxodisulfate, and 152.5 g of water is then immediately added to the mixture at 80° C. and within 90 min. Stirring is then continued at 80° C. for 1 h. Finally, the dispersion is neutralized by addition of 2 g of 25% ammonia solution. This results in an aqueous dispersion with a solids content of 32%. The dispersion has film-forming properties at room temperature.

To produce films, the dispersion was poured into a dish and dried at room temperature for 5 days. The films exhibit the following mechanical properties:

| | |
|---|---|
| Tensile strength [MPa] | 15.8 |
| Tensile strain at break [%] | 290 |
| E-modulus of elasticity [MPa] | 2.57 |
| Shore A hardness | 71 |

### Example 6

A fine-particle emulsion is produced from 2.2 g of dilauroyl peroxide, 170 g of butyl acrylate, 60 g of styrene, 132 g of dispersion of colloidal SiO₂ particles (30% by weight in butyl acrylate, spherical 25 nm particles, agglomerate-free, surface reactively modified with 3-methacryloxypropyltrimethoxysilane), 1.6 g of sodium salts of C₁₄-C₁₆-alkanesulfonic acids, and 281 g of water, by emulsification (60 s at 24,000 rpm in an UltraTurrax).

Said emulsion is added to an initial charge of 0.5 g of sodium salts of C₁₄-C₁₆-alkanesulfonic acids in 805 g of water which has been heated to 80° C., and is polymerized at 80° C. within 60 min under inert gas. An emulsion produced from 200 g of MMA, 4.2 g of butyl acrylate, 0.45 g of 2-ethylhexyl thioglycolate, 0.15 g of sodium salts of C₁₄-C₁₆-alkanesulfonic acids, 0.43 g of sodium peroxodisulfate, and 153 g of water by emulsification for 30 s at 24,000 rpm in an UltraTurrax is then immediately added to the mixture at 80° C. within 60 min. Stirring is then continued at 80° C. for 1 hour. This results in a dispersion with particle size of about 0.5 μm and a solids content of 30%.

The dispersion is filled into PE bottles and frozen at −25° C. After thawing, in each PE bottle a white, elastic block is obtained from which the water can be removed by compression. Drying results in white plastic bodies, which can be formed at 150° C. to transparent, tough plastics sheets.

1. A hybrid particle comprising at least two vinyl polymers, vinyl polymer A and vinyl polymer B, wherein vinyl polymer A comprises colloidal SiO₂ particles with an average particle size from 1 to 150 nm and vinyl polymer B is capable of crosslinking hybrid particles to one another.

2. The hybrid particle according to claim 1, wherein vinyl polymer A and vinyl polymer B differ from one another in chemical constitution, chemical nonuniformity, tacticity, glass transition temperature, molecular weight, and degree of crosslinking.

3. The hybrid particle according to claim 1, wherein vinyl polymer A is a chemically crosslinked and vinyl polymer B is not a chemically crosslinked.

4. The hybrid particle according to claim 1, wherein the SiO₂ particles have been surface-modified with at least one of unreactive groups and with reactive groups.

5. The hybrid particle according to claim 1, wherein
a) a polymer of vinyl monomers which is chemically crosslinked via reactively modified SiO₂ particles, and
b) a polymer of vinyl monomers which is not chemically crosslinked.

6. The hybrid particle according to claim 5, wherein the vinyl monomers were selected from the group consisting of the dienes, such as isoprene or butadiene, vinyl halides, such as vinyl chloride, vinyl esters, such as vinyl acetate and vinyl esters of α-branched monocarboxylic acids, styrene and substituted styrenes, acrylic and methacrylic acid and derivatives thereof e.g. esters of (meth)acrylic acid, (meth)acrylonitriles, and (meth)acrylic anhydrides, and particularly preferably from the group of the vinyl esters, styrene and substituted styrenes, and acrylic and methacrylic acid derivatives, and very particularly preferably from the group of the vinyl esters, styrene, and acrylic and methacrylic acid, and esters thereof.

7. The hybrid particle according to claim 1, wherein a ratio by weight of vinyl polymer A to vinyl polymer B is in a range from 10:1 to 1.

8. The hybrid particle according to claim 1, with an average particle size from 100 to 5000 nm, preferably from 150 to 2000 nm, particularly preferably between 200 and 1500 nm.

9. The hybrid particle according to claim 1, wherein the hybrid particle comprises at least 10 SiO₂ particles, preferably at least 25 SiO₂ particles, particularly preferably at least 50 SiO₂ particles.

10. The hybrid particles according to claim 1, wherein the SiO₂ particles are composed of at least 50%, preferably at least 70%, more preferably at least 80%, more preferably at least 90%, of separate primary particles not being aggregated or agglomerated.

11. The hybrid particle according to claim 1, wherein the content of SiO₂ particles is from 1 to 40% by weight, preferably from 1 to 30% by weight, more preferably from 1 to 15% by weight, particularly preferably from 2 to 8% by weight.

12. The hybrid particle according to claim 1, wherein the acrylate is methyl acrylate, ethyl acrylate, butyl acrylate, or ethylhexyl acrylate.

13. The hybrid particle according to claim 6, wherein vinyl polymer A and vinyl polymer B are copolymers of acrylate and methacrylate.

14. The hybrid particle according to claim 1, wherein vinyl polymer A and vinyl polymer B are copolymers of one or more of the group consisting of methyl methacrylate with methyl acrylate, ethyl acrylate, butyl acrylate, ethylhexyl acrylate.

15. A method for producing a hybrid particle according to one or more of the claim 1, wherein
a) in a first polymerization stage, one or more vinyl monomer(s) is/are polymerized in the presence of colloidal SiO₂ particles with an average particle size from 1 to 150 nm, and
b) in a second polymerization stage, one or more vinyl monomer(s) is/are polymerized in the presence of the vinyl polymer obtained in the first polymerization stage.

16. The method according to claim 15, wherein the SiO₂ particles in the first polymerization stage are dispersed in a non-aqueous phase emulsified in water, and in particular in the vinyl monomers.

17. Aqueous polymer dispersion comprising hybrid particles according to claim 1.

18. Polymeric material comprising crosslinked hybrid particles which comprise at least two vinyl polymers (vinyl polymers A and B), wherein vinyl polymer A comprises colloidal SiO₂ particles with an average particle size from 1 to 150 nm, and vinyl polymer B crosslinks the hybrid particles to one another.

19. Polymeric material according to claim 18, wherein the vinyl polymer B forms a substantially continuous phase between the phases of the vinyl polymer A.

20. Polymeric material obtainable via removal of the water from a polymer dispersion according to claim 17.
